(19) United States
(12) Patent Application Publication
(10) Pub. No.: US 2014/0126543 A1
(43) Pub. Date: May 8, 2014

(54) Method and device for personal-network based seamless handover

(71) Applicants: Lizhe Yao, Shenzhen (CN); Jun Chen, Shenzhen (CN); Guoqiang Shang, Shenzhen (CN)

(72) Inventors: Lizhe Yao, Shenzhen (CN); Jun Chen, Shenzhen (CN); Guoqiang Shang, Shenzhen (CN)

(73) Assignee: ZTE CORPORATION, Shenzhen, Guangdong (CN)

(21) Appl. No.: 14/233,112

(22) PCT Filed: Jul. 18, 2012
(86) PCT No.: PCT/CN2012/078823

§ 371 Date: Jan. 15, 2014

(30) Foreign Application Priority Data
Jul. 20, 2011 (CN) 201110203996.2

(51) Int. Cl. H04W 36/38

(52) U.S. Cl. CPC H04W 36/38
USPC 370/331

(57) ABSTRACT

An embodiment of the disclosure discloses a method for personal-network based seamless handover, wherein when a personal network gateway receives a service handover request or needs to hand over a service, a target personal network device is selected; and when the target personal network device agrees to perform a service handover, the service handover from an original personal network device to the target personal network device is performed. An embodiment of the disclosure further discloses a device for personal-network based seamless handover, wherein a target selecting unit is configured to select a target personal network device; and a service handover unit is configured to perform a service handover from an original personal network device to the target personal network device when the target personal network device agrees to perform the service handover. With the method and device according to embodiments of the disclosure, it is possible to provide an effective solution for implementing seamless handover of a service within a personal network when service handover needs to be performed.

### TECHNICAL FIELD

The disclosure relates to personal-network based handover techniques, and in particular to a method and device for personal-network based seamless handover.

### BACKGROUND

With the development of science and techniques, people possess more and more personal devices, such as a mobile phone, a laptop, a PDA, an MP3, an MP4 and so on, with increasing capabilities; and most of the devices are capable of short-range communication; therefore there is an increasing desire for these devices around people to be connected together into a Personal area Network (PN) to share a resource and a capability of each other.

FIG. 1 shows a schematic diagram of networking among various devices in a PN including personal network devices, a personal network gateway, and a personal network server, a networking relationship thereamong being that: the personal network consists of the personal network gateway, a personal network device 1, a personal network device 2, a personal network device 3, and a personal network device 4. The personal network is connected to the personal network server via the personal network gateway of the personal network.

However, for various reasons (for example, when the personal network device has low battery or the personal network device leaves the present personal network), the personal network device cannot be able to continue using a current service, and needs to hand the service over to another personal network device. At present, there lacks an effective solution for implementing seamless handover of a service within a personal network aiming at such a need.

### SUMMARY

In view of this, it is desired that the disclosure provides a method and device for personal-network based seamless handover, capable of providing an effective solution for implementing seamless handover of a service within a personal network when service handover needs to be performed.

To this end, a technical solution according to an embodiment of the disclosure is implemented as follows.

A method for personal-network based seamless handover includes:

when a personal network gateway receives a service handover request or needs to hand over a service, a target personal network device is selected; and

when the target personal network device agrees to perform a service handover, the service handover from an original personal network device to the target personal network device is performed.

The service handover request may be initiated or triggered by a user, a personal network server, the service, a personal network device, the personal network gateway, or a particular event.

The target personal network device may be selected to be another personal network device other than the original personal network device in a same personal network.

The method may further include that: when an initiator initiating or triggering the service handover is not the personal network gateway, before the selecting a target personal network device, the initiator sends the personal network gateway the service handover request containing service description information; and the personal network gateway selects the target personal network device according to the service description information, or sends the service handover request to a target-personal-network-device selecting entity, which selects the target personal network device.

When an initiator initiating or triggering the service handover is the personal network gateway, the personal network gateway may select the target personal network device directly according to local service description information.

The method may further include that: before performing the service handover, service synchronization between the original personal network device and the target personal network device is performed;

when the service description information includes the synchronization information for the service synchronization, the target personal network device acquires the synchronization information by receiving the synchronization information sent by the personal network gateway; and

when the service description information include no synchronization information for the service synchronization, the target personal network device acquires the synchronization information by interacting with the original personal network device or by interacting with the personal network server.

The method may further include that: after the performing the service handover from an original personal network device to the target personal network device, a handover-completes response is returned to the initiator initiating or triggering the service handover, and the service previously used by the original personal network device is stopped.

The stopping the service previously used by the original personal network device may specifically include that:

when the initiator is not the original personal network device, the original personal network device is instructed, via the personal network gateway, to stop using the service; and when the initiator is the personal network gateway, the personal network gateway directly instructs the original personal network device to stop using the service.

The method may further include that after the returning a handover-completes response to the initiator initiating or triggering the service handover, the personal network gateway sends a service server an updating message, and the service server changes a service provider in the service description information according to the updating message.

The stopping the service previously used by the original personal network device may specifically include that:

when the initiator is not the original personal network device, the original personal network device is instructed, via the personal network gateway, to stop using the service; and when the initiator is the personal network gateway, the personal network gateway directly instructs the original personal network device to stop using the service.

A device for personal-network based seamless handover is located at a personal network gateway or a personal network server, and includes a target selecting unit and a service handover unit, wherein

the target selecting unit is configured to select a target personal network device when the personal network gateway receives a service handover request or needs to hand over a service; and

the service handover unit is configured to perform a service handover from an original personal network device to the target personal network device when the target personal network device agrees to perform the service handover.

The device may further include a service handover triggering unit configured to have the service handover request be initiated or triggered by a user, a personal network server, the service, a personal network device, the personal network gateway, or a particular event.

The target selecting unit may be further configured to select another personal network device other than the original personal network device in a same personal network as a target-personal-network-device selecting entity.

The target selecting unit may be further configured such that, when an initiator initiating or triggering the service handover is not the personal network gateway, the initiator sends the personal network gateway the service handover request containing service description information; and

the personal network gateway selects the target personal network device according to the service description information; or the personal network gateway sends the service handover request to a target-personal-network-device selecting entity, which then selects the target personal network device.

The target selecting unit may be further configured such that, when an initiator initiating or triggering the service handover is the personal network gateway, the personal network gateway selects the target personal network device directly according to local service description information.

The device may further include a service stopping unit configured to, after the service handover from an original personal network device to the target personal network device is performed, return a handover-completes response to the initiator initiating or triggering the service handover, and stop the service previously used by the original personal network device.

The device may further include a service updating unit configured to send a service server an updating message, such that the service server changes a service provider in the service description information according to the updating message.

With an embodiment of the disclosure, when a service handover request is received or when handover needs to be performed for a service, a personal network gateway selects a target personal network device; when the target personal network device agrees to perform a service handover, the service handover from an original personal network device to the target personal network device is performed.

With an embodiment of the disclosure, it is possible to provide an effective solution for implementing seamless handover of a service within a personal network when service handover needs to be performed, such that a service on an original personal network device is handed over to a target personal network device.

### BRIEF DESCRIPTION OF THE DRAWINGS

FIG. 1 is a schematic diagram of networking among various devices in a PN in related art;

FIG. 2 is a flowchart showing the basic principle of a method for seamless handover according to an embodiment of the disclosure;

FIG. 3 is a schematic diagram showing the networking of specific embodiments 1 and 3 of the disclosure; and

FIG. 4 is a schematic diagram showing the networking of specific embodiment 2 of the disclosure.

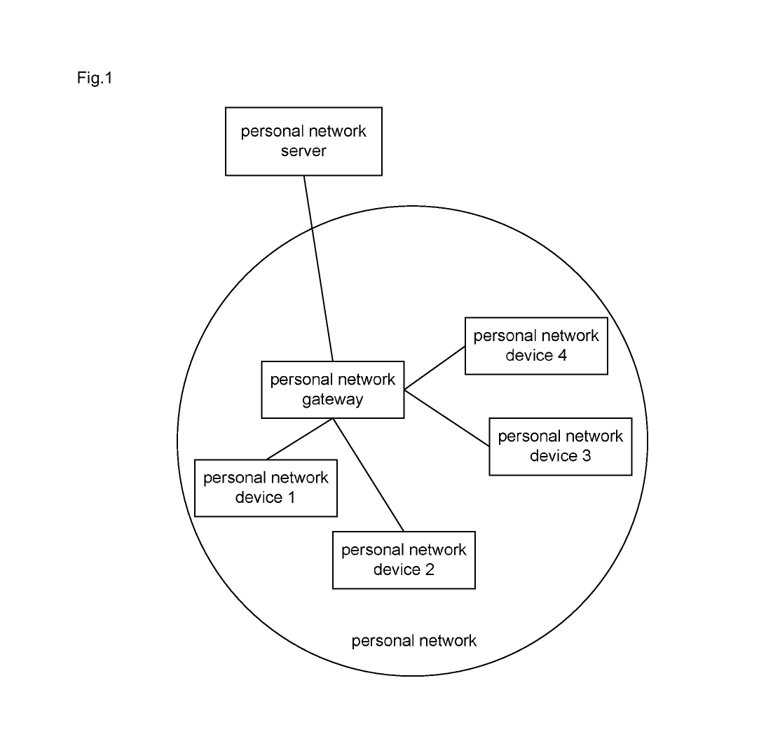

### DETAILED DESCRIPTION

Implementation of a technical solution of the disclosure is further elaborated below with reference to the drawings.

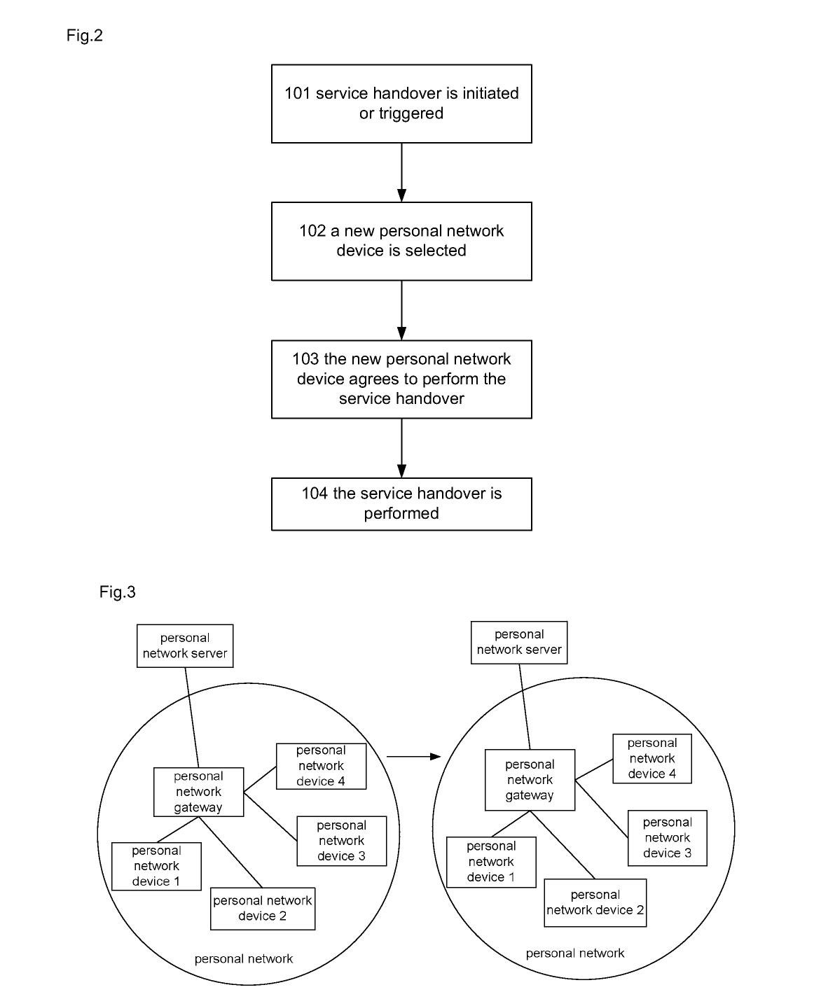

A method for personal-network based seamless handover, namely, service handover within a personal network, a flow showing the basic principle thereof being shown in FIG. 2, the method mainly including steps as follows.

Step 101: service handover may be initiated or triggered by a user, a personal network server, a service, a personal network device, a personal network gateway, or a particular event.

Here, the particular event includes power shortage of the personal network device, the user leaving or entering a particular area such as a home, a car, a hotel, or the like, which is not elaborated.

Here, in step 101, when the initiator of the service handover is not the personal network gateway, for example, the initiator of the service handover is the personal network device, then the initiator sends the personal network gateway a service handover request containing service description information such as service identifier information and the like; when the initiator of the service handover is the personal network gateway itself, this step is skipped.

Preferably, if the service description information contained in step 101 includes synchronization information for the service synchronization, then in subsequent step 103, the synchronization information is also sent by the personal network gateway to a new personal network device, and in step 104, the new personal network device performs service synchronization according to the synchronization information; if the service description information contained in step 101 includes no synchronization information for the service synchronization, then in subsequent step 104, before the new personal network device performs the service handover, the new personal network device may further acquire the synchronization information by interacting with the original personal network device or via a service server.

Step 102: the new personal network device is selected and the service handover is performed.

Here, in step 102, when the new personal network device is selected and the service handover is performed, the new personal network device may be selected to be another personal network device other than the original personal network device in a same personal network. The new personal network device may include: the user, the personal network server, the service, the personal network gateway, or another personal network device other than the original personal network device.

Here, there may be multiple standards for selecting the new personal network device, such as random selection, selection according to a device capacity, selection according to a service type and the like. Here, as to the device capacity, both a personal network device or the personal network gateway are logic entities that may exist in a specific physical device (such as a mobile phone), so the device capacity herein refers to the capacity of the physical device in which such logic entities are located, which is not elaborated.

Here, the method includes that: before the new personal network device is selected and the service handover is performed,

A1: the personal network gateway sends the service handover request to an entity in charge of selecting the new personal network device, and if the personal network gateway is in charge of selecting the new personal network device, this step is skipped.

Selecting the new personal network device and performing the service handover includes that:

B1: the entity in charge of selecting the new personal network device selects the new personal network device.

The method includes that: after the new personal network device is selected and the service handover is performed,

C1: the entity in charge of selecting the new personal network device returns a result of the selection to the personal network gateway, and if the personal network gateway is in charge of selecting the new personal network device, this step is skipped.

Step 103: the new personal network device agrees to perform the service handover.

Here, the method includes that: before the new personal network device agrees to perform the service handover, the personal network gateway sends the selected new personal network device the service handover request containing the service description information such as the service identifier.

If the new personal network device agrees to perform handover and is capable of supporting the service, then subsequent step 104 is performed; if the new personal network device does not agree to perform handover, then a handover-cannot-be-performed response is returned to the initiator, and the flow goes back to the step 102 to reselect a new personal network device.

Step 104: the service handover from the original personal network device to the new personal network device is performed.

Here, the performing the service handover includes that: the new personal network device acquires the service according to the received service description information, and perform synchronization with the service on the original personal network device, such as time synchronization, status synchronization, and the like.

The method includes that: after performing the service handover, the handover-completes response is returned to the personal network gateway; the personal network gateway returns the handover-completes response to the initiator; the original personal network device stops using the service.

Preferably, in step 104, if the initiator is not the original personal network device, then the initiator needs to instruct, via the personal network gateway, the original personal network device to stop using the service; if the personal network gateway is the initiator, then the personal network gateway directly instructs the original personal network device to stop using the service.

Preferably, the method further includes that: after the handover-completes response is returned to the personal network gateway, the personal network gateway sends a service server an updating message, and the service server changes a service provider in the service description information according to the updating message.

In addition, if there are more than one services being used or provided by the personal network requiring the handover, then the handover as described needs to be performed for each service thereof.

Here, the new personal network device herein may also be a target personal network device corresponding to the original personal network device.

A device for personal-network based seamless handover is located at a personal network gateway, and the device includes a target selecting unit and a service handover unit. The target selecting unit is configured to select a target personal network device when the personal network gateway receives a service handover triggering request or needs to hand over a service; the service handover unit is configured to perform a service handover from an original personal network device to the target personal network device when the target personal network device agrees to perform the service handover.

Here, the device further includes a service handover triggering unit configured to have the service handover request be initiated or triggered by a user, a personal network server, the service, a personal network device, the personal network gateway, or a particular event.

Here, the target selecting unit is further configured to select another personal network device other than the original personal network device in a same personal network as a target-personal-network-device selecting entity. The target-personal-network-device selecting entity may include: the user, the personal network server, the service, the personal network gateway, or another personal network device other than the original personal network device.

Here, the target selecting unit may be further configured such that, when an initiator initiating or triggering the service handover is not the personal network gateway, the initiator may send the personal network gateway the service handover request containing service description information; and the personal network gateway may select the target personal network device according to the service description information, or send the service handover request to a target-personal-network-device selecting entity, and the target-personal-network-device selecting entity may select the target personal network device.

Here, the target selecting unit is configured such that, when an initiator initiating or triggering the service handover is the personal network gateway, the personal network gateway may select the target personal network device directly according to local service description information.

Here, the device may further include a service stopping unit configured to, after the service handover from an original personal network device to the target personal network device is performed, return a handover-completes response to the initiator initiating or triggering the service handover, and stop the service previously used by the original personal network device.

Here, the device may further include a service updating unit configured to send a service server an updating message, such that the service server changes a service provider in the service description information according to the updating message.

The disclosure is illustrated below with examples.

### Embodiment 1

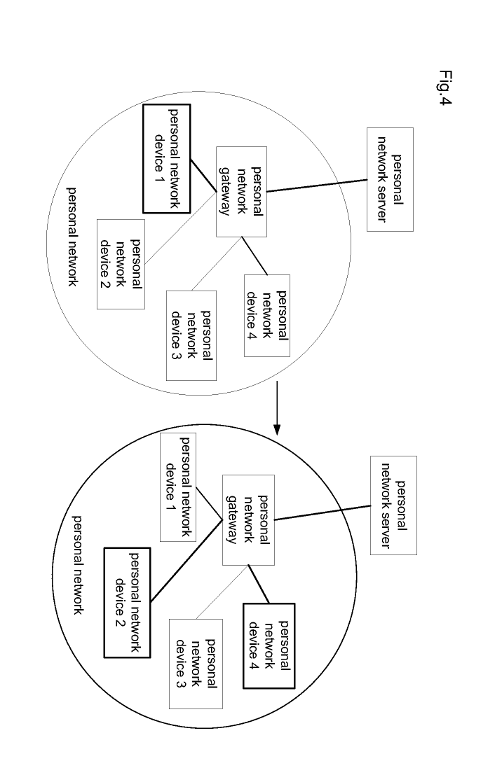

A user A has a personal network including a personal network gateway and four personal network devices, a schematic diagram showing the networking being shown in FIG. 3, wherein a personal network device 1 and a personal network device 4 support a video service. The user A is using a video-on-demand service through the personal network gateway using the personal network device 1 when the personal network device 1 runs out of battery power. In such a case, a seamless handover flow includes the following steps.

Step 201: a user A sends a personal network gateway a service handover request containing description information of a video-on-demand service using a personal network device 1.

Step 202: after receiving the service handover request, the personal network gateway determines that a personal network device 4 is selected as a new personal network device after handover according to the description information of the video-on-demand service.

Step 203: the personal network gateway sends the personal network device 4 a service handover request containing the description information of the video-on-demand service.

Step 204: the personal network device 4 agrees on the handover after receiving the service handover request from the personal network gateway.

Step 205: the personal network device 4 establishes, according to the received description information of the video-on-demand service, a connection with a service server through the personal network gateway.

Step 206: the personal network device 4 sends, through the personal network gateway, the personal network device 1 a synchronization-information acquiring request to acquire synchronization information for service synchronization.

Step 207: after receiving the synchronization-information acquiring request, the personal network gateway forwards the synchronization-information acquiring request to the personal network device 1.

Step 208: after receiving the synchronization-information acquiring request, the personal network device 1 returns to the personal network gateway a synchronization-information-request response containing present information of the video-on-demand service, such as a present playing time and the like.

Step 209: the personal network gateway forwards the synchronization-information-request response to the personal network device 4.

Step 210: after receiving the synchronization-information-request response, the personal network device 4 plays the video-on-demand service starting from the present playing time according to the acquired synchronization information.

Step 211: the personal network device 4 returns a handover-completes response to the personal network gateway.

Step 212: the personal network gateway returns to the personal network device 1 a handover-completes response.

Step 213: after receiving the handover-completes response, the personal network device 1 ends the video-on-demand service.

### Embodiment 2

A user A has a personal network including a personal network gateway and four personal network devices, a schematic diagram showing the networking being shown in FIG. 4, wherein a personal network device 1, a personal network device 2, and a personal network device 4 support a video service. The user A is using a video-on-demand service through the personal network gateway using the personal network device 1 when the personal network device 1 needs to leave the personal network. In such a case, a seamless handover flow includes the following steps.

Step 301: a user A sends a personal network gateway a service handover request containing description information of a video-on-demand service using a personal network device 1, wherein the description information of the video-on-demand service includes synchronization information for service synchronization, such as a present playing time and the like.

Step 302: after receiving the service handover request, the personal network gateway determines that a personal network device 4 is selected as a new personal network device after handover according to the description information of the video-on-demand service.

Step 303: the personal network gateway sends the personal network device 4 a service handover request containing the description information of the video-on-demand service.

Step 304: after receiving the service handover request from the personal network gateway, the personal network device 4 refuses the handover, and returns to the personal network gateway a handover refusing response.

Step 305: after receiving the handover refusing response, the personal network gateway reselects a personal network device 2 as the new personal network device after handover.

Step 306: the personal network gateway sends the personal network device 2 a service handover request containing the description information of the video-on-demand service, wherein the description information of the video-on-demand service includes synchronization information for service synchronization, such as a present playing time and the like.

Step 307: the personal network device 2 agrees on the handover after receiving the service handover request from the personal network gateway.

Step 308: the personal network device 2 establishes, according to the received description information of the video-on-demand service, a connection with a service server through the personal network gateway.

Step 309: the personal network device 2 plays, according to the received synchronization information, the video-on-demand service starting from the present playing time.

Step 310: the personal network device 2 returns a handover-completes response to the personal network gateway.

Step 311: the personal network gateway returns to the personal network device 1 a handover-completes response.

Step 312: after receiving the handover-completes response, the personal network device 1 ends the video-on-demand service.

### Embodiment 3

A user A has a personal network including a personal network gateway and four personal network devices, a schematic diagram showing the networking being shown in FIG. 3, wherein a personal network device 1 and a personal network device 4 support a video service. The user A is using a video-on-demand service through the personal network gateway using the personal network device 1 when the personal network device 1 runs out of battery power. In such a case, a seamless handover flow includes the following steps.

Step 401: a user A sends a personal network gateway a service handover request containing description information of a video-on-demand service using a personal network device 1.

Step 402: after receiving the service handover request, the personal network gateway determines that a personal network device 4 is selected as a new personal network device after handover according to the description information of the video-on-demand service.

Step 403: the personal network gateway sends the personal network device 4 a service handover request containing the description information of the video-on-demand service.

Step 404: the personal network device 4 agrees on the handover after receiving the service handover request from the personal network gateway.

Step 405: the personal network device 4 establishes, according to the received description information of the video-on-demand service, a connection with a service server through the personal network gateway.

Step 406: the personal network device 4 acquires synchronization information for service synchronization from a service server.

Step 407: the personal network device 4 plays the video-on-demand service starting from a present playing time according to the acquired synchronization information.

Step 408: the personal network device 4 returns a handover-completes response to the personal network gateway.

Step 409: the personal network gateway returns to the personal network device 1 a handover-completes response.

Step 410: after receiving the handover-completes response, the personal network device 1 ends the video-on-demand service.

Note here that the embodiment differs from Embodiment 1 in that the synchronization information is acquired from the service server instead of from the original personal network device through the personal network gateway.

### Embodiment 4

A user A has a personal network including a personal network gateway and four personal network devices, a schematic diagram showing the networking being shown in FIG. 3, wherein a personal network device 1 and a personal network device 4 support a picture sharing service. The user A is using the picture sharing service through the personal network gateway using the personal network device 1 when the personal network device 1 runs out of battery power. In such a case, a seamless handover flow includes the following steps.

Step 501: a user A sends a personal network gateway a service handover request containing description information of a picture sharing service using a personal network device 1.

Step 502: after receiving the service handover request, the personal network gateway determines, according to the description information of the picture sharing service, that a personal network device 4 is selected as a new personal network device after handover.

Step 503: the personal network gateway sends the personal network device 4 a service handover request containing the description information of the picture sharing service.

Step 504: the personal network device 4 agrees on the handover after receiving the service handover request from the personal network gateway.

Step 505: the personal network device 4 acquires, according to the received description information of the picture sharing service, synchronization information for service synchronization including a picture, related information, and the like from the personal network device 1.

Specifically, the personal network device 4 may acquire the synchronization information through a connection established with a service server, or from the personal network device 1 through the personal network gateway.

Step 506: the personal network device 4 acquires according to the acquired synchronization information, the picture sharing service from the personal network device 1.

Step 507: the personal network device 4 returns a handover-completes response to the personal network gateway.

Step 508: the personal network gateway sends a service-network server an updating message such that the service server updates the description information of the picture sharing service, in which a service provider changes from the personal network device 1 to the personal network device 4.

Step 509: the personal network server updates, according to the received updating message, the description information of the picture sharing service, changing the service provider from the personal network device 1 to the personal network device 4, and returns to the personal network gateway an updating response.

Step 510: the personal network gateway returns to the personal network device 1 a handover-completes response.

Step 511: after receiving the handover-completes response, the personal network device 1 ends the picture sharing service.

What described are merely preferred embodiments of the disclosure and are not intended to limit the scope of the disclosure.

1. A method for personal-network based seamless handover, comprising:
when a personal network gateway receives a service handover request or needs to hand over a service, selecting a target personal network device; and
when the target personal network device agrees to perform a service handover, performing the service handover from an original personal network device to the target personal network device.

2. The method according to claim 1, wherein the service handover request is initiated or triggered by a user, a personal network server, the service, a personal network device, the personal network gateway, or a particular event.

3. The method according to claim 1, wherein the target personal network device is selected to be another personal network device other than the original personal network device in a same personal network.

4. The method according to claim 2, further comprising: when an initiator initiating or triggering the service handover is not the personal network gateway, before the selecting a target personal network device, sending, by the initiator, the personal network gateway the service handover request containing service description information; and
selecting, by the personal network gateway, the target personal network device according to the service description information; or sending, by the personal network gateway, the service handover request to a target-personal-network-device selecting entity, and selecting, by the target-personal-network-device selecting entity, the target personal network device.

5. The method according to claim 2, wherein when an initiator initiating or triggering the service handover is the personal network gateway, selecting, by the personal network gateway, the target personal network device directly according to local service description information.

6. The method according to claim 4, further comprising: before performing the service handover, performing service synchronization between the original personal network device and the target personal network device;
when the service description information comprises the synchronization information for the service synchronization, acquiring, by the target personal network device, the synchronization information by receiving the synchronization information sent by the personal network gateway; and
when the service description information comprise no synchronization information for the service synchronization, acquiring, by the target personal network device, the synchronization information by interacting with the original personal network device or by interacting with the personal network server.

7. The method according to claim 1, further comprising: after the performing the service handover from an original personal network device to the target personal network device, returning a handover-completes response to the initiator initiating or triggering the service handover, and stopping the service previously used by the original personal network device.

8. The method according to claim 7, wherein the stopping the service previously used by the original personal network device comprises:
when the initiator is not the original personal network device, instructing, via the personal network gateway, the original personal network device to stop using the service; and
when the initiator is the personal network gateway, instructing directly by the personal network gateway, the original personal network device to stop using the service.

9. The method according to claim 7, further comprising: after the returning a handover-completes response to the initiator initiating or triggering the service handover, sending, by the personal network gateway, a service server an updating message, and changing, by the service server, a service provider in the service description information according to the updating message.

10. The method according to claim 9, wherein the stopping the service previously used by the original personal network device comprises:
when the initiator is not the original personal network device, instructing, via the personal network gateway, the original personal network device to stop using the service; and
when the initiator is the personal network gateway, instructing directly by the personal network gateway, the original personal network device to stop using the service.

11. A device for personal-network based seamless handover, located at a personal network gateway or a personal network server, the device comprising a target selecting unit and a service handover unit, wherein
the target selecting unit is configured to select a target personal network device when the personal network gateway receives a service handover request or needs to hand over a service; and
the service handover unit is configured to perform a service handover from an original personal network device to the target personal network device when the target personal network device agrees to perform the service handover.

12. The device according to claim 11, further comprising a service handover triggering unit configured to have the service handover request be initiated or triggered by a user, a personal network server, the service, a personal network device, the personal network gateway, or a particular event.

13. The device according to claim 11, wherein the target selecting unit is further configured to select another personal network device other than the original personal network device in a same personal network as a target-personal-network-device selecting entity.

14. The device according to claim 12, wherein the target selecting unit is further configured to, when an initiator initiating or triggering the service handover is not the personal network gateway, have the initiator send the personal network gateway the service handover request containing service description information; and
to have the personal network gateway select the target personal network device according to the service description information; or to have the personal network gateway send the service handover request to a target-personal-network-device selecting entity, and to have the target-personal-network-device selecting entity select the target personal network device.

15. The device according to claim 12, wherein the target selecting unit is configured to, when an initiator initiating or triggering the service handover is the personal network gateway, have the personal network gateway select the target personal network device directly according to local service description information.

16. The device according to claim 11, further comprising a service stopping unit configured to, after the service handover from an original personal network device to the target personal network device is performed, return a handover-completes response to the initiator initiating or triggering the service handover, and stop the service previously used by the original personal network device.

17. The device according to claim 11, further comprising a service updating unit configured to send a service server an updating message, such that the service server changes a service provider in the service description information according to the updating message.

18. The method according to claim 5, further comprising: before performing the service handover, performing service synchronization between the original personal network device and the target personal network device;
when the service description information comprises the synchronization information for the service synchronization, acquiring, by the target personal network device, the synchronization information by receiving the synchronization information sent by the personal network gateway; and
when the service description information comprise no synchronization information for the service synchronization, acquiring, by the target personal network device, the synchronization information by interacting with the original personal network device or by interacting with the personal network server.

19. The method according to claim 2, further comprising: after the performing the service handover from an original personal network device to the target personal network device, returning a handover-completes response to the initiator initiating or triggering the service handover, and stopping the service previously used by the original personal network device.

20. The method according to claim 3, further comprising: after the performing the service handover from an original personal network device to the target personal network device, returning a handover-completes response to the initiator initiating or triggering the service handover, and stopping the service previously used by the original personal network device.
